(19) United States
(12) Patent Application Publication
(10) Pub. No.: US 2014/0001958 A1
(43) Pub. Date: Jan. 2, 2014

(54) CIRCUIT, DEVICE AND METHOD OF DIRECTLY DRIVING LED

(71) Applicant: Samsung Electro-Mechanics Co., Ltd., Gyeonggi-do (KR)

(72) Inventors: Deuk Hee Park, Gyeonggi-do (KR); Sang Hyun Cha, Gyeonggi-do (KR); Youn Joong Lee, Gyeonggi-do (KR); Chang Seok Lee, Gyeonggi-do (KR); Jae Shin Lee, Gyeonggi-do (KR)

(21) Appl. No.: 13/927,049

(22) Filed: Jun. 25, 2013

(30) Foreign Application Priority Data
Jun. 28, 2012 (KR) 10-2012-0070048

(51) Int. Cl. H05B 33/08

(52) U.S. Cl. CPC H05B 33/0851
USPC 315/122

(57) ABSTRACT

Provided is a circuit, a device and a method of direct-driving an LED. According to an embodiment, the LED direct-driving circuit includes an LED unit having a plurality of LED groups serially connected to each other, a switching unit including a plurality of switches respectively connected to the plurality of LED groups, each switch configured to emit light from at least one LED group serially connected to the switch according to an ON operation, and a switching control unit configured to compare a signal according to a line voltage sensed from an input voltage of the LED unit with an output voltage of the LED unit to calculate a comparison value, generate a PWM carrier signal having a frequency varied according to the line voltage, and output a control signal for controlling the switching unit by comparing the comparison value with the frequency-varied PWM carrier signal.

### CROSS-REFERENCE TO RELATED APPLICATIONS

This application claims the benefit of Korean Patent Application No. 10-2012-0070048 filed with the Korea Intellectual Property Office on Jun. 28, 2012, the disclosure of which is incorporated herein by reference.

### BACKGROUND OF THE INVENTION

1. Field of the Invention

The present invention relates to a circuit, a device and a method of directly driving an LED, and more particularly, to a circuit, a device and a method of directly driving an LED that are capable of changing a frequency of a PWM carrier signal according to a line voltage to constantly maintain a current capacity provided to the LED, thereby improving line regulation.

2. Description of the Related Art

Since a light emitting diode (LED) has advantages such as a compact structure, low power consumption, rapid emission driving, and long emission lifespan, conventional illumination light sources are being increasingly replaced with the light emitting diode.

In general, an LED driving circuit converts an alternate current (AC) input into a direct current (DC) signal using a converter including a transformer and a smoothing capacitor, driving the light emitting diode. Here, while the transformer has an advantage of electrically separating a primary side from a secondary side, the transformer has disadvantages such as a large volume and high cost.

The smoothing capacitor generally uses a large capacity of electrolytic condenser. However, since the electrolytic condenser also has disadvantages such as a large volume, high cost, and shorter lifespan than the LED, causing reduction in lifespan of the entire system.

In order to solve the problems, instead of the LED driving device using the converter including the transformer and the smoothing capacitor, a LED driving device using a constant current source has been proposed.

However, in the conventional LED driving device including the constant current source, when an LED is driven by an AC direct-driving method, an output current is varied according to an increase in line voltage to decrease line regulation characteristics.

### RELATED ART DOCUMENT

### Patent Document

(Patent Document 1) Korean Patent Registration No. 10-0942234 (published on Feb. 12, 2010)
(Patent Document 2) US Patent Laid-open Publication No. US20100308738 (published on Dec. 9, 2010)
(Patent Document 3) US Patent Laid-open Publication No. US20100308731 (published on Dec. 9, 2010)

### SUMMARY OF THE INVENTION

The present invention has been invented in order to overcome the above-described problems and it is, therefore, an object of the present invention to provide a circuit, a device and a method of directly driving an LED that are capable of changing a frequency of a PWM carrier signal according to a line voltage to constantly maintain a current capacity provided to the LED, thereby improving line regulation.

In accordance with one aspect of the present invention to achieve the object, there is provided a light emitting diode (LED) direct-driving circuit including an LED unit having a plurality of LED groups serially connected to each other; a switching unit including a plurality of switches respectively connected to the plurality of LED groups, each switch configured to emit light from at least one LED group serially connected to the corresponding switch according to an ON operation; and a switching control unit configured to compare a signal according to a line voltage sensed from an input voltage of the LED unit with an output voltage of the LED unit to calculate a comparison value, generate a pulse width modulation (PWM) carrier signal having a frequency varied according to the line voltage, and output a control signal for controlling the switching unit by comparing the comparison value with the frequency-varied PWM carrier signal.

In addition, in one example, the switching control unit may include a voltage comparing unit configured to compare the signal according to the line voltage sensed by the input voltage of the LED unit with the output voltage of the LED unit to output a comparison signal; an oscillator unit configured to generate and output the PWM carrier signal having a frequency according to the line voltage; a PWM signal generating unit configured to compare the comparison signal output from the voltage comparing unit with the PWM carrier signal output from the oscillator unit to generate a duty-adjusted PWM signal; and a control signal output unit configured to output a control signal for controlling the switching unit according to the PWM signal and the line voltage output from the PWM signal generating unit.

Here, in one example, the voltage comparing unit may include a reference signal providing unit configured to generate and provide a reference voltage signal according to the line voltage; an averaging unit configured to receive the output voltage of the LED unit and average a value of the output voltage; and a comparison amplification unit configured to compare an average output voltage generated from the averaging unit with the reference voltage signal to output a comparison signal.

Here, in one example, the reference signal providing unit may include a reference voltage generating unit configured to generate a reference voltage signal from the line voltage; an analog-digital converter (ADC) configured to generate a digital signal according to a level of the line voltage and provide the digital signal to the control signal output unit; and a digital-analog converter (DAC) configured to receive a digital signal generated from the ADC and select an analog reference voltage signal generated from the reference voltage generating unit according to the digital signal to provide the analog reference voltage signal to the voltage comparing unit.

In addition, here, in one example, the control signal output unit may include a buffer unit configured to buffer a signal output from the PWM signal generating unit; and a demux unit configured to output a control signal for driving any one of the plurality of switches of the switching unit according to a signal output from the buffer unit in response to the ADC.

Further, in one example, the oscillator unit may include a line regulation unit configured to receive the line voltage and generate a line current varied according to a magnitude of the line voltage; and a reference wave generating unit, in which a charge time is varied by a ramp current that the line current is subtracted from a constant current source, configured to generate and output the PWM carrier signal having a variable frequency.

In another example, the PWM signal generating unit may include a pulse signal generating unit configured to compare the comparison signal output from the voltage comparing unit with the PWM carrier signal output from the oscillator unit to generate a pulse signal; and a latch unit configured to latch the pulse signal output from the pulse signal generating unit in response to a reference clock signal generated and output from the oscillator unit according to the PWM carrier signal.

In addition, according to one example, the LED direct-driving circuit may include a power supply unit configured to rectify alternate current (AC) power to provide the input voltage to the LED unit; and a line voltage sensing unit configured to distribute the input voltage provided from the power supply unit to detect the distributed line voltage.

Next, in order to solve the problems, according to a second aspect of the present invention, there is provided an LED direct-driving device including a power supply unit configured to rectify AC power to provide an input voltage; a line voltage sensing unit configured to distribute the input voltage provided from the power supply unit to detect a distributed line voltage; a plurality of LED groups configured to receive the input voltage from the power supply unit and including at least one LED serially connected to each other; a plurality of switches respectively connected to the plurality of LED groups and emitting light from at least one LED group serially connected to the corresponding switch according to an ON operation; an output signal sensing unit connected to a lower end of the plurality of switches and configured to detect an output voltage of the plurality of LED groups; and a switching control unit configured to compare a signal according to the line voltage detected by the line voltage sensing unit with an output voltage detected by the output signal sensing unit to calculate a comparison value, generate a PWM carrier signal having a frequency varied according to the detected line voltage, and compare the comparison value with the frequency-varied PWM carrier signal to output a control signal for controlling the plurality of switches.

In addition, in one example, the switching control unit may include a voltage comparing unit configured to compare a signal according to the line voltage detected by the line voltage sensing unit with an output voltage detected by the output signal sensing unit to output a comparison signal; an oscillator unit configured to generate the PWM carrier signal having a frequency varied according to the detected line voltage; a PWM signal generating unit configured to compare the comparison signal output from the voltage comparing unit with the PWM carrier signal output from the oscillator unit to generate a duty-adjusted PWM signal; and a control signal output unit configured to a control signal for controlling the plurality of switches according to the PWM signal output from the PWM signal generating unit and the detected line voltage.

Here, according to one example, the voltage comparing unit may include a reference signal providing unit configured to generate and provide a reference voltage signal according to the line voltage; an averaging unit configured to average a value of the output voltage detected by the output signal sensing unit; and a comparison amplification unit configured to compare an average output voltage generated from the averaging unit with the reference voltage signal to output a comparison signal.

Here, in another example, the reference signal providing unit may include a reference voltage generating unit configured to generate a reference voltage signal from the line voltage; an ADC configured to generate a digital signal according to a level of the detected line voltage and provide the digital signal to the control signal output unit; and a DAC configured to receive a digital signal generated from the ADC and select an analog reference voltage signal generated from the reference voltage generating unit according to the digital signal to provide the an analog reference voltage signal to the voltage comparing unit.

In addition, here, in one example, the control signal output unit may include a buffer unit configured to buffer a signal output from the PWM signal generating unit; and a demux unit configured to output a control signal for driving any one of the plurality of switches according to a signal output from the buffer unit in response to an output of the ADC.

Further, in one example, the oscillator unit may include a line regulation unit configured to receive the line voltage from the line voltage sensing unit to generate a line current varied according to a magnitude of the line voltage; and a reference wave generating unit, in which a charge time is varied by a ramp current that the line current is subtracted from a constant current source, configured to generate and output the PWM carrier signal having a variable frequency.

In another example, the PWM signal generating unit may include a pulse signal generating unit configured to compare the comparison signal output from the voltage comparing unit with the PWM carrier signal output from the oscillator unit to generate a pulse signal; and a latch unit configured to latch the pulse signal output from the pulse signal generating unit in response to a reference clock signal generated and output from the oscillator unit according to the PWM carrier signal.

Next, in order to solve the problems, according to a third aspect of the present invention, there is provided an LED direct-driving method of providing an input voltage to an LED unit serially connected to a plurality of LED groups, controlling a plurality of switches respectively connected to the plurality of LED groups to perform an ON operation, and emitting light from at least one LED group serially connected to a corresponding switch, the LED direct-driving method including a reference signal frequency change step of generating and outputting a PWM carrier signal having a frequency varied according to a line voltage sensed from an input voltage of the LED unit; a voltage comparing step of comparing a signal according to the line voltage with an output voltage of the LED unit to output a comparison signal; a PWM signal generating step of comparing the PWM carrier signal having a frequency varied and output in the reference signal frequency change step with the comparison signal output from the voltage comparing step to generate a duty-adjusted PWM signal; and a control signal output step of outputting a control signal for controlling each of the plurality of switches according to the PWM signal output from the PWM signal generating step and the line voltage.

In addition, in one example, the reference signal frequency change step may include a step of receiving the line voltage and generating a line current varied according to a magnitude of the line voltage; and a step of varying a charge time by a ramp current that the line current is subtracted from a constant current source and generating and outputting the PWM carrier signal having a variable frequency.

In another example, the voltage comparing step may include a reference signal providing step of generating and providing a reference voltage signal according to the line voltage; an averaging step of detecting an output voltage of the LED unit and averaging a value of the detected output voltage; and a comparison output step of comparing an average output voltage generated in the averaging step with the reference voltage signal provided in the reference signal providing step to output a comparison signal.

In addition, in one example, the reference signal providing step may include a reference voltage generating step of generating a reference voltage signal from the line voltage; an analog-digital conversion step of generating a digital signal according to a level of the line voltage and providing the digital signal to the control signal output step; and a digital-analog conversion step of receiving the digital signal generated in the analog-digital conversion step and selecting an analog reference voltage signal generated in the reference voltage generating step according to the digital signal to provide the analog reference voltage signal to the comparison output step, wherein the control signal output step may include a step of buffering a signal output in the PWM signal generating step; and a step of outputting a control signal for driving any one of the plurality of switches according to a signal output after the buffering in response to an output of the analog-digital conversion step.

In addition, according to one example, a reference clock signal may be additionally generated and output according to the PWM carrier signal having a frequency varied in the reference signal frequency change step, and the PWM signal generating step may include a step of comparing the PWM carrier signal having a frequency varied and output in the reference signal frequency change step with the comparison signal output in the voltage comparing step to generate and output a pulse signal; and a step of latching the pulse signal output in response to the reference clock signal output in the reference signal frequency change step.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a circuit view schematically showing an LED direct-driving circuit according to an embodiment of the present invention;

FIG. 2 is a circuit view schematically showing an LED direct-driving device including an LED direct-driving circuit according to another embodiment of the present invention;

FIG. 3 is a circuit view showing an oscillator unit of an LED direct-driving circuit or device of FIGS. 1 and/or 2;

FIG. 4 is a graph schematically showing an output waveform of an LED direct-driving circuit according to an example of the present invention;

FIG. 5 is a graph showing a current flowing an LED group of the LED direct-driving circuit and an average of an output voltage of the LED group according to the example of the present invention;

FIG. 6 is a flowchart schematically showing an LED direct-driving method according to another embodiment of the present invention; and

FIG. 7 is a flowchart schematically showing an LED direct-driving method according to still another embodiment of the present invention.

### DETAILED DESCRIPTION OF THE PREFERABLE EMBODIMENTS

Hereinafter, exemplary embodiments of the present invention will be described in detail. The following embodiments are described in order to enable those of ordinary skill in the art to embody and practice the present invention. To clearly describe the present invention, parts not relating to the description are omitted from the drawings.

It will be understood that when an element or layer is referred to as being “on” or “connected to” another element or layer, it can be directly on or directly connected to the other element or layer, or intervening elements or layers may be present, unless the context clearly indicates otherwise.

Terms used herein are provided for explaining embodiments of the present invention, not limiting the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated components, motions, and/or devices, but do not preclude the presence or addition of one or more other components, motions, and/or devices thereof.

First, an LED direct-driving circuit of a first embodiment of the present invention will be described in detail with reference to the accompanying drawings. Here, reference numerals not shown in a reference drawing may be reference numerals in another drawing showing the same configuration.

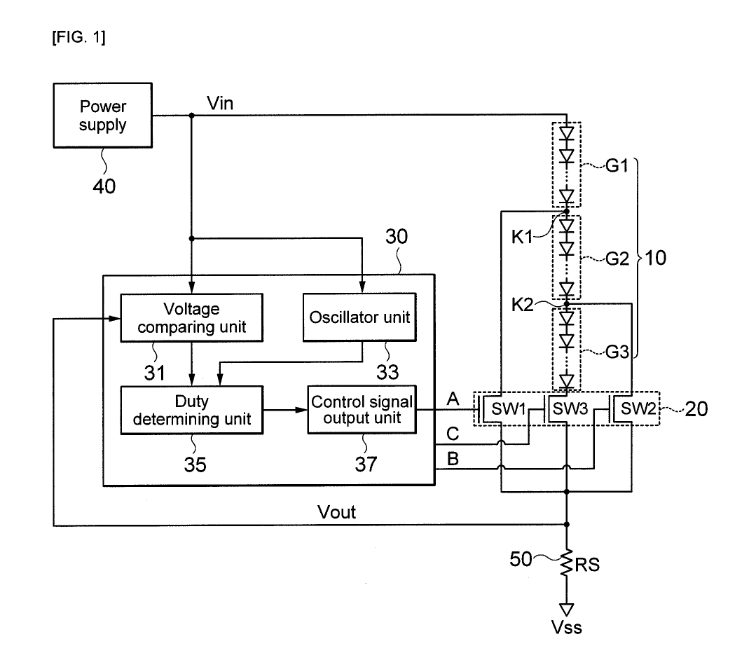

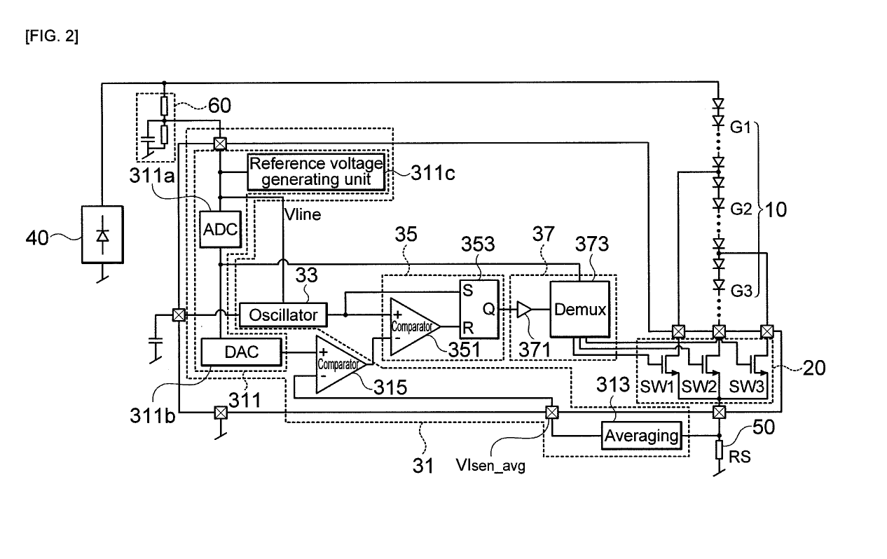

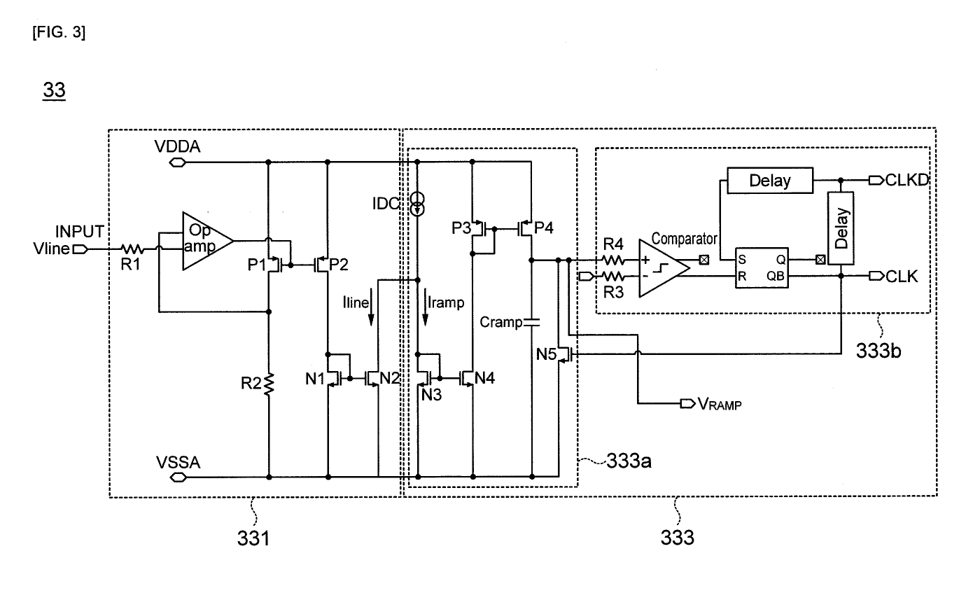

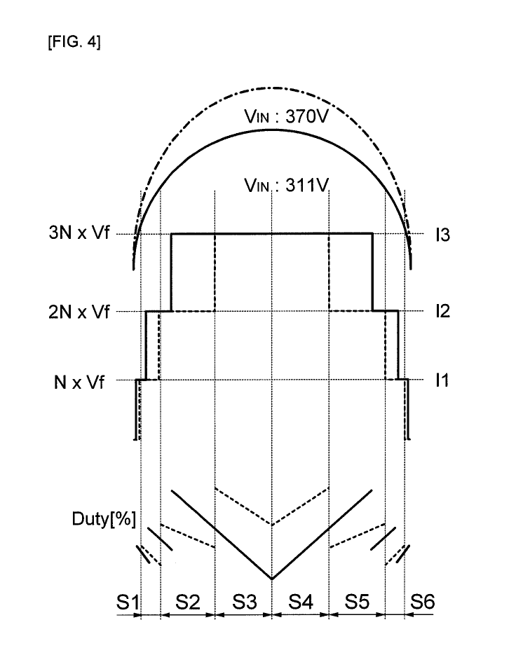

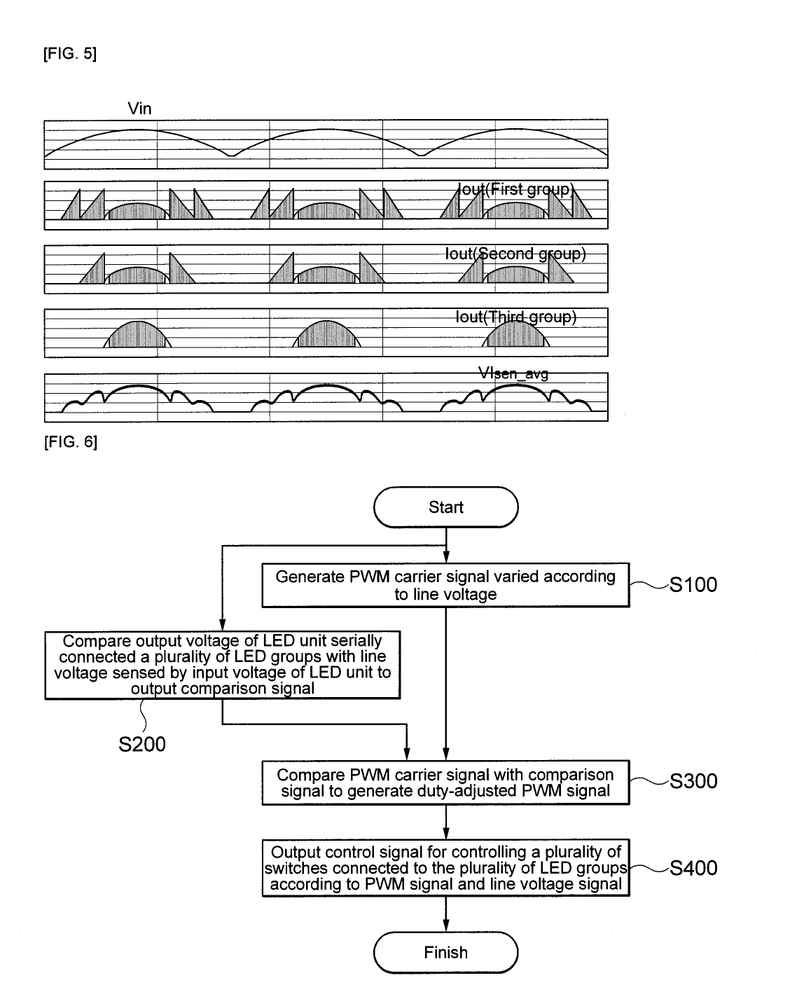

FIG. 1 is a circuit view schematically showing an LED direct-driving circuit according to an embodiment of the present invention, FIG. 2 is a circuit view schematically showing an LED direct-driving device including an LED direct-driving circuit according to another embodiment of the present invention, FIG. 3 is a circuit view showing an oscillator unit of an LED direct-driving circuit or device of FIGS. 1 and/or 2, FIG. 4 is a graph schematically showing an output waveform of an LED direct-driving circuit according to an example of the present invention, and FIG. 5 is a graph showing a current flowing an LED group of the LED direct-driving circuit and an average of an output voltage of the LED group according to the example of the present invention.

Referring to FIG. 1, the LED direct-driving circuit according to the first embodiment may include an LED unit 10, a switching unit 20 and a switching control unit 30. The respective configurations will be described in detail with reference to FIGS. 1, 2 and/or 3.

First, the LED unit 10 of the LED direct-driving circuit according to the first embodiment will be described.

The LED unit 10 has a plurality of LED groups G1, G2 and G3 serially connected to each other. Each of the plurality of LED groups G1, G2 and G3 includes at least one LED. While three groups of LEDs are shown in FIG. 2, it is merely illustrative and the number of LED groups may be variously varied. In each group, at least one LED is serially connected. Referring to FIGS. 1 and 2, the LED unit 10 receives a rectified input voltage from a power supply unit 40. For example, AC power may be full-wave rectified through a bridge circuit to be provided to the LED unit 10 as an input voltage. In addition, referring to FIG. 2, a line voltage sensing unit 60 may be further installed between the power supply unit 40 and the LED unit 10. The line voltage sensing unit 60 senses a line voltage distributed according to the input voltage provided to the LED unit 10.

Next, the switching unit 20 of the LED direct-driving circuit according to the first embodiment will be described.

Referring to FIGS. 1 and 2, the switching unit 20 includes a plurality of switches SW1, SW2 and SW3 connected to the plurality of LED groups G1, G2 and G3 of the LED unit 10, respectively. Each of the plurality of switches SW1, SW2 and SW3 of the switching unit 20 is turned on to emit at least one LED group serially connected to the corresponding switch. Here, when an LED group is parallelly connected to the switch, which is turned ON, the corresponding LED group is turned OFF. In addition, referring to FIGS. 1 and 2, the switching unit 20 has the plurality of switches SW1, SW2 and SW3, which are parallelly connected to each other. Here, an output signal sensing unit 50 configured to sense an output voltage of the LED unit 10 may be installed at a lower end of the plurality of switches SW1, SW2 and SW3, which are parallelly connected to each other.

Next, the switching control unit 30 of the LED direct-driving circuit according to the first embodiment will be described in detail.

Referring to FIGS. 1 and 2, the switching control unit 30 compares a signal according to a line voltage sensed from the input voltage of the LED unit 10 with an output voltage of the LED unit 10 to calculate a comparison value. In addition, the switching control unit 30 varies a frequency of a PWM carrier signal according to the line voltage. Moreover, the switching control unit 30 compares the comparison value with the frequency-varied carrier signal to output a control signal for controlling the switching unit 20.

According to the ON operation of the switching unit 20 according to the control of the switching control unit 30, the number of LEDs of the LED unit 10, which are to be turned ON, is adjusted. That is, the input voltage to the LED unit 10 is sensed as the line voltage through voltage distribution, the switching control unit 30 changes the frequency of the PWM carrier signal according to the line voltage to output the control signal, and thus, the switching unit 20 can be turned ON to adjust the number of LEDs, which are to be turned ON. Adjustment of the number of LEDs is performed by the switch, which will be described by an example. As the switch is disposed at a lower end of the LED and controlled by the switching control unit 30 through a PWM method, the current capacity can be uniformly maintained to reduce heat generation.

The switching control unit 30 will be described in more detail with reference to FIGS. 1 and 2.

Referring to FIGS. 1 and 2, the switching control unit 30 may include a voltage comparing unit 31, an oscillator unit 33, a PWM signal generating unit 35 and a control signal output unit 37. The respective configurations of the switching control unit 30 will be described in detail with reference to FIGS. 1, 2 and/or 3.

First, the voltage comparing unit 31 of the switching control unit 30 will be described with reference to the drawings.

In FIGS. 1 and/or 2, the voltage comparing unit 31 compares the signal according to the line voltage sensed from the input voltage of the LED unit 10 with the output voltage of the LED unit 10 to output a comparison signal. Here, the line voltage is detected through voltage distribution of the input voltage from the line voltage sensing unit 60 of FIG. 2 to the LED unit 10, and the output voltage of the LED unit 10 is detected by the output signal sensing unit 50.

Here, the voltage comparing unit 31 will be described in detail with reference to FIG. 2. In one example, the voltage comparing unit 31 may include a reference signal providing unit 311, an averaging unit 313 and a comparison amplification unit 315.

The reference signal providing unit 311 of the voltage comparing unit 31 will be described in detail. The reference signal providing unit 311 generates and provides a reference voltage signal according to the line voltage. That is, the reference signal providing unit 311 generates the reference voltage signal according to the line voltage to provide the signal to the comparison amplification unit 315 to be compared with the average output voltage in the comparison amplification unit 315.

More specifically reviewing FIG. 2, in one example, the reference signal providing unit 311 may include a reference voltage generating unit 311c, an analog-digital converter (ADC, 311a) and a digital-analog converter (DAC, 311b). The reference voltage generating unit 311c generates the reference voltage signal from the line voltage. Here, the reference voltage signal may be a signal having a plurality of levels according to line voltage levels. Here, referring to FIG. 2, one of a plurality of levels of reference voltage signals generated from the reference voltage generating unit 311c can be selected in the DAC 311b according to the digital signal received from the ADC 311a to be provided as a reference voltage of the comparison amplification unit 315. For example, the signal generated from the reference voltage generating unit 311c is provided to the DAC 311b, and at this time, the DAC 311b can select the reference voltage signal corresponding to the digital signal among the reference voltage generated from the reference voltage generating unit 311c according to the digital signal received from the ADC 311a, and provide the reference voltage signal to the comparison amplification unit 315 of the voltage comparing unit 31.

The ADC 311a can generate a digital signal according to the line voltage, for example, the line voltage level, detected by, for example, the line voltage sensing unit 60, and provide the generated digital signal to the control signal output unit 37. In addition, the digital signal generated from the ADC 311a is input into the DAC 311b. The case in which the digital signal generated from the ADC 311a is provided to the control signal output unit 37 will be described. Here, in one example, the control signal output unit 37 includes a buffer unit 371 and a demux unit 373, and can output a control signal for driving any one of the plurality of switches SW1, SW2 and SW3 according to the output signal of the buffer unit 371 in response to the digital signal output from the ADC 311a in the demux unit 373.

In addition, the ADC 311a can provide the digital signal generated according to the line voltage level to the DAC 311b. The DAC 311b can provide the analog reference voltage signal to the voltage comparing unit 31, specifically, to the comparison amplification unit 315 of FIG. 2, according to the digital signal input from the ADC 311a. Here, the analog reference voltage signal is one of the plurality of levels of reference voltage signals generated and output from the reference voltage generating unit 311c of FIG. 2, and can be selected in the DAC 311b according to the digital signal to e provided to a voltage comparing unit 315, for example, a comparison amplification unit 315. Accordingly, the reference voltage signal according to the line voltage level is provided to the voltage comparing unit 31, for example the comparison amplification unit 315 of FIG. 2.

Next, referring to FIG. 2, the averaging unit 313 of the voltage comparing unit 31 will be described in detail. The averaging unit 313 receives the output voltage of the LED unit 10 to average of a value of the output voltage. For example, the averaging unit 313 averages the output voltages of the LED unit 10 detected by the output signal sensing unit 50. Here, the output signal sensing unit 50 detects the output current of the LED unit 10, and the averaging unit 313 can average the detected output currents to obtain the averaged output voltage. In addition, a voltage according to the output current of the LED unit 10 in the output signal sensing unit 50 may be detected and averaged by the averaging unit 313 to obtain the averaged output voltage.

Next, the comparison amplification unit 315 of the voltage comparing unit 31 will be described in detail with reference to FIG. 2. The comparison amplification unit 315 includes a comparison amplifier, compares the average output voltage generated from the averaging unit 313 with the reference voltage signal according to the level of the line voltage, and outputs the comparison signal. Here, the reference voltage signal according to the level of the line voltage provided to the comparison amplification unit 315 may be a reference voltage signal selected depending on the digital signal according to the line voltage level in the DAC 311b. The DAC 311b can receive the digital signal generated according to the line voltage level in the ADC 311a, select one reference voltage signal among the reference voltages generated from the reference voltage generating unit 311c according to the corresponding digital signal, and provides the reference voltage signal to the voltage comparing unit 31, specifically, to the comparison amplification unit 315 of FIG. 2.

For example, the comparison amplifier of the comparison amplification unit 315 may be an error amplifier, and at this time, the error amplifier can compare the average output voltage with the reference voltage signal and amplify an error to output the error-amplified comparison signal. The comparison signal output from the comparison amplification unit 315 is input to the PWM signal generating unit 35, for example, a pulse signal generating unit 351.

Next, the oscillator unit 33 of the switching control unit 30 will be described with reference to FIGS. 1, 2 and/or 3.

The oscillator unit 33 of the switching control unit 30 generates and outputs a PWM carrier signal having a frequency varied according to the line voltage. In the conventional art, while the reference waveform generated from the oscillator has a fixed frequency, the frequency of the PWM carrier signal can be changed according to the line voltage in the embodiment to further improve the line regulation characteristics. That is, when the line voltage is increased, the frequency of the PWM carrier signal is lowered, and when the line voltage is reduced, the frequency of the PWM carrier signal is increased, uniformly maintaining a current flowing through the LED unit 10.

The oscillator unit 33 will be described in detail with reference to FIG. 3. In one example, the oscillator unit 33 may include a line regulation unit 331 and a reference wave generating unit 333.

Here, the line regulation unit 331 of the oscillator unit 33 receives, for example, the line voltage detected by the line voltage sensing unit 60 and generates the line current varied according to the magnitude of the line voltage. In addition, the reference wave generating unit 333 of the oscillator unit 33, specifically, a carrier signal generating unit 333a of FIG. 3 is charged by a ramp current that a line current is subtracted from the constant current source, and generates and outputs the PWM carrier signal. Here, the carrier signal generating unit 333a of FIG. 3 has a charge time varied according to the magnitude of the line voltage, and thus, the frequency of the PWM carrier signal charged and output by a capacitor Cramp is varied. The PWM carrier signal can be output at an output node of the carrier signal generating unit 333a. For example, the PWM carrier signal may be a ramp wave, a triangle wave, a sawtooth wave, or the like, in one example, a ramp wave. For example, the PWM carrier signal output from the reference wave generating unit 333, for example, a ramp wave is input to the PWM signal generating unit 35, for example, the pulse signal generating unit 351.

In addition, referring to FIG. 3, in one example, a clock generating unit 333b of the reference wave generating unit 333 can receive the PWM carrier signal generated from the carrier signal generating unit 333a to generate a reference clock signal through a comparator, or a comparator and a flip-flop circuit. The output reference clock signal may be provided to, for example, a latch unit 353 of FIG. 2.

For example, an operation of the oscillator unit 33 will be described in detail with reference to FIG. 3. The line regulation unit 331 compares and amplifies a line voltage Vline and a fed back inner reference voltage in an OP amp, operates a current mirror of transistors N1 and N2 according to the OP amp output, and subtracts a line current Iline from a constant current source IDC. As the line voltage Vline is increased in the line regulation unit 331, when the line current Iline is subtracted from the constant current source IDC, a ramp current Iramp flows to a current mirror of transistors N3 and N4 of the reference wave generating unit 333, specifically, the carrier signal generating unit 333a of FIG. 3. Accordingly, the ramp current Iramp is charged to the capacitor Cramp by a current mirror of transistors P3 and P4. A switch N5 parallelly connected to the capacitor Cramp is feedback-operated according to a reference clock signal output from the clock generating unit 333b of FIG. 3, performing charge and discharge in the capacitor Cramp. The reference wave generating unit 333, specifically, the carrier signal generating unit 333a of FIG. 3 generates and outputs a PWM carrier signal V_{RAMP}, for example, a ramp wave, according to the charge and discharge of the capacitor Cramp. Here, the PWM carrier signal V_{RAMP} has a frequency varied according to the magnitude of the line voltage Vline. In addition, the PWM carrier signal V_{RAMP} generated in the carrier signal generating unit 333a is provided to the clock generating unit 333b to be output as the reference clock signal via the comparator and the flip-flop circuit of the clock generating unit 333b.

Here, when the line voltage Vline is increased, the line current Iline is increased and thus the ramp current Iramp is reduced. When the ramp current Iramp is reduced, a charge time to the capacitor Cramp is increased and thus the PWM carrier signal V_{RAMP}, for example, a frequency of the ramp wave is reduced. On the other hand, when the line voltage Vline is reduced, the ramp current Iramp is increased to lengthen the charge time, and thus, the PWM carrier signal V_{RAMP}, for example, the frequency of the ramp wave is increased.

In addition, referring to FIG. 3, the clock generating unit 333b receives the PWM carrier signal V_{RAMP}, for example, the ramp wave generated from the carrier signal generating unit 333a, and generates and outputs a reference clock signal. Specifically, the comparator of the clock generating unit 333b receives and compares the PWM carrier signal V_{RAMP}, for example, the ramp wave to output a comparison value, and generates and outputs a reference clock signal in response to the comparison vale of the comparator in the flip-flop circuit of the clock generating unit 333b. Here, the output reference clock signal may be provided to, for example, the latch unit 353 of FIG. 2.

Next, the PWM signal generating unit 35 of the switching control unit 30 will be described in detail with reference to FIGS. 1 and/or 2.

In FIGS. 1 and/or 2, the PWM signal generating unit 35 compares the comparison signal output from the voltage comparing unit 31 with the PWM carrier signal, for example, the ramp wave output from the oscillator unit 33, and generates and outputs a duty-adjusted PWM signal. Here, the PWM carrier signal generated/output from the oscillator unit 33 has a frequency varied according to the line voltage. Accordingly, since the PWM carrier signal having the frequency varied according to the line voltage is compared with the comparison signal output from the voltage comparing unit 31 to generate a PWM signal, the line regulation can be improved.

Here, referring to FIG. 2, in one example, the PWM signal generating unit 35 may include the pulse signal generating unit 351 and the latch unit 353. The pulse signal generating unit 351 compares the comparison signal output from the voltage comparing unit 31 with the PWM carrier signal output from the oscillator unit 33 to generate a pulse signal. Then, the latch unit 353 latches the pulse signal output from the pulse signal generating unit 351 in response to the reference clock signal generated and output from the oscillator unit 33 according to the PWM carrier signal. For example, the latch unit 353 receives the reference wave generating unit 333 of the oscillator unit 33, specifically, the reference clock signal generated and output according to the PWM carrier signal in the clock generating unit 333b of FIG. 3, and latches the output signal pulse signal output from the pulse signal generating unit 351 in response to the reference clock signal. The output of the latch unit 353 may be provided to the control signal output unit 37, for example, the buffer unit 371 of FIG. 2.

Next, the control signal output unit 37 of the switching control unit 30 will be described in detail with reference to FIGS. 1 and/or 2.

In FIGS. 1 and/or 2, the control signal output unit 37 outputs a control signal for controlling the switching unit 20 according to the PWM signal and the line voltage output from the PWM signal generating unit 35.

Here, referring to FIG. 2, in one example, the control signal output unit 37 may include the buffer unit 371 and the demux unit 373. The buffer unit 371 buffers a signal output from the PWM signal generating unit 35. In addition, the demux unit 373 can output a control signal for driving any one of the plurality of switches SW1, SW2 and SW3 of the switching unit 20 according to the signal output from the buffer unit 371 in response to the line voltage signal. Here, the line voltage signal applied to the demux unit 373 may be, for example, a digital signal generated from the ADC 311a according to the line voltage level detected by the line voltage sensing unit 60 as shown in FIG. 2.

Next, an LED direct-driving circuit according to still another example will be described with reference to FIGS. 1 and 2.

Referring to FIGS. 1 and 2, the LED direct-driving circuit according to one example may further include the power supply unit 40 and the line voltage sensing unit 60. In addition, in still another example, the LED direct-driving circuit may further include the output signal sensing unit 50. Here, the output signal sensing unit 50 includes a sensing resistance Rs to detect an output current of the LED unit 10 or a voltage according to the output current. The signal detected by the output signal sensing unit 50 is averaged by the averaging unit 313 to obtain the averaged output voltage, and the obtained average output voltage is provided to the voltage comparing unit 31.

Referring to FIGS. 1 and 2, the power supply unit 40 of the LED direct-driving circuit according to one example rectifies AC power to provide an input voltage Vin to the LED unit 10. In addition, the line voltage sensing unit 60 distributes and senses the input voltage Vin provided from the power supply unit 40. The line voltage Vline is a voltage detected by the voltage distribution in the line voltage sensing unit 60.

Next, the LED direct-driving device of the second embodiment of the present invention will be described in detail with reference to the drawings. Here, the LED direct-driving circuits according to the first embodiment and FIGS. 1, 4 and 5 may be referenced, and detailed description thereof will be omitted.

FIG. 2 is a circuit view schematically showing the LED direct-driving device including the LED direct-driving circuit according to still another embodiment of the present invention, and FIG. 3 is a circuit view showing the oscillator unit of the LED direct-driving device of FIG. 2.

Referring to FIG. 2, the LED direct-driving device according to the second embodiment of the present invention may include the power supply unit 40, the line voltage sensing unit 60, the plurality of LED groups G1, G2 and G3 (10), the plurality of switches SW1, SW2 and SW3 (20), the output signal sensing unit 50 and the switching control unit 30.

Here, the plurality of LED groups G1, G2 and G3 (10), the plurality of switches SW1, SW2 and SW3 (20) and the switching control unit 30 may correspond to the LED unit 10, the switching unit 20 and the switching control unit 30 of the LED direct-driving circuit according to the first embodiment. Accordingly, the detailed description of the LED direct-driving circuit according to the first embodiment may be referenced, and overlapping description will be omitted.

Referring to FIG. 2, the power supply unit 40 of the LED direct-driving device according to one example rectifies AC power to provide the input voltage Vin. For example, the power supply unit 40 may be constituted by a bridge circuit to full-wave rectify the AC power, providing the input voltage Vin to the plurality of LED groups G1, G2 and G3 (10).

Next, in FIG. 2, the line voltage sensing unit 60 of the LED direct-driving device according to one example distributes the input voltage Vin provided from the power supply unit 40 to detect the distributed line voltage Vline. For example, the line voltage sensing unit 60 may include a serially connected resistance to distribute the input voltage Vin provided from the power supply unit 40 and detect the distributed voltage, sensing the line voltage therefrom.

Next, referring to the LED direct-driving device of FIG. 2, the plurality of LED groups G1, G2 and G3 (10) of the LED direct-driving device according to one example receive the input voltage from the power supply unit 40. In addition, each of the plurality of LED groups G1, G2 and G3 (10) includes at least one LED. Here, the plurality of LED groups G1, G2 and G3 (10) are serially connected to each other.

Next, the plurality of switches SW1, SW2 and SW3 (20) of the LED direct-driving device according to one example will be described. In FIG. 2, the plurality of switches SW1, SW2 and SW3 (20) are connected to the plurality of LED groups G1, G2 and G3 (10), respectively. Here, each switch turns ON at least one LED group serially connected to the corresponding switch according to the ON operation. When the LED group parallelly connected to the ON-operating switch is present, the corresponding LED group is turned OFF. In addition, referring to FIGS. 1 and 2, the plurality of switches SW1, SW2 and SW3 (20) are parallelly connected to each other.

Next, the output signal sensing unit 50 of the LED direct-driving device of FIG. 2 will be described. The output signal sensing unit 50 is connected to a lower end of the plurality of switches SW1, SW2 and SW3 (20). Here, the output signal sensing unit 50 can detect output voltages of the plurality of LED groups G1, G2 and G3 (10). The output signal sensing unit 50 includes a sensing resistance. For example, as shown in FIG. 2, the plurality of switches SW1, SW2 and SW3 (20) are parallelly connected to each other, a sensing resistance is provided at the lower end of the plurality of switches SW1, SW2 and SW3 (20) to sense the voltage applied from a sensing resistance RS, and thus, the output signal sensing unit 50 can sense the output voltage of the LED group emitting light according to the ON-operating switch.

Next, the switching control unit 30 of the LED direct-driving device according to one example of FIG. 2 will be described.

Referring to FIG. 2, the switching control unit 30 compares the line voltage detected by the line voltage sensing unit 60 with the output voltage detected by the output signal sensing unit 50 to calculate a comparison value. In addition, the switching control unit 30 varies a frequency of the PWM carrier signal according to the line voltage. Moreover, the switching control unit 30 compares the comparison value with the frequency-varied PWM carrier signal to output a control signal for controlling the plurality of switches SW1, SW2 and SW3 (20).

Hereinafter, the switching control unit 30 of the LED direct-driving device according to one example will be described in detail.

Referring to FIG. 2, in one example of the LED direct-driving device, the switching control unit 30 may include the voltage comparing unit 31, the oscillator unit 33, the PWM signal generating unit 35 and the control signal output unit 37. Hereinafter, the respective configurations of the switching control unit 30 will be described in detail.

First, referring to FIG. 2, the voltage comparing unit 31 of the switching control unit 30 compares the line voltage detected by the line voltage sensing unit 60 with the output voltage detected by the output signal sensing unit 50 to output the comparison signal.

Here, according to one example, the voltage comparing unit 31 of the switching control unit 30 may include the reference signal providing unit 311, the averaging unit 313 and the comparison amplification unit 315.

The reference signal providing unit 311 of the voltage comparing unit 31 will be described in detail. The reference signal providing unit 311 generates a reference voltage signal according to the line voltage and provides the reference voltage signal to the comparison amplification unit 315 to be compared with the average output voltage in the comparison amplification unit 315. In one example, the reference signal providing unit 311 may include a reference voltage generating unit 311c, an analog-digital converter 311a and a digital-analog converter 311b.

More specifically reviewing FIG. 2, the reference voltage generating unit 311c of the reference signal providing unit 311 generates a reference voltage signal from the line voltage. Here, the reference voltage signal may be signal having a plurality of levels according to the line voltage levels. Here, referring to FIG. 2, the reference voltage signal corresponding to the digital signal received from the ADC 311a in the DAC 311b among the plurality of levels of reference voltage signal generated from the reference voltage generating unit 311c may be selected by the DAC 311b to be provided to the comparison amplification unit 315 of the voltage comparing unit 31.

The analog-digital converter 311a generates, for example, a line voltage detected by the line voltage sensing unit 60, for example, a digital signal according to the line voltage level, and provides the generated digital signal to the control signal output unit 37 and the digital-analog converter 311b. In one example, the control signal output unit 37 including the buffer unit 371 and the demux unit 373 can output a control signal for driving any one of the plurality of switches SW1, SW2 and SW3 according to the output signal of the buffer unit 371 in response to the digital signal output from the ADC 311a in the demux unit 373.

Meanwhile, the digital-analog converter 311b can provide an analog reference voltage signal to the voltage comparing unit 31, for example, the comparison amplification unit 315 according to the digital signal input from the ADC 311a. Here, the analog reference voltage signal, which is one of the plurality of levels of reference voltage signals generated and output from the reference voltage generating unit 311c of FIG. 2, can be selected by the digital-analog converter 311b according to the digital signal to be provided to the voltage comparing unit 315.

Next, referring to FIG. 2, the averaging unit 313 and the comparison amplification unit 315 of the voltage comparing unit 31 will be described in detail. The averaging unit 313 averages values of the output signal detected by the output signal sensing unit 50 to obtain the averaged output voltage. Then, the comparison amplification unit 315 includes, for example, a comparison amplifier, and compares the average output voltage generated from the averaging unit 313 with the reference voltage signal provided from the reference signal providing unit 311 to output the comparison signal. In one example, the comparison amplifier of the comparison amplification unit 315 may be an error amplifier. Here, the error amplifier can compare the average output voltage with the reference voltage signal to amplify an error, and output the amplified comparison signal. The comparison signal output from the comparison amplification unit 315 is input to the PWM signal generating unit 35, for example, specifically, the pulse signal generating unit 351 of FIG. 2.

Next, a specific example of the oscillator unit 33 of the switching control unit 30 will be described with reference to FIGS. 2 and/or 3.

Referring to FIGS. 2 and/or 3, the oscillator unit 33 generates and outputs the PWM carrier signal having a frequency varied according to the line voltage detected by the line voltage sensing unit 60. As the frequency of the PWM carrier signal according to the embodiment is varied according to the line voltage, the line regulation can be further improved. That is, when the line voltage is increased, the frequency of the PWM carrier signal is reduced, and, on the other hand, when the line voltage is reduced, the frequency of the PWM carrier signal is increased, uniformly maintaining the current flowing through the plurality of LED groups G1, G2 and G3 (10).

More specifically reviewing the oscillator unit 33 according to one example with reference to FIG. 3, the oscillator unit 33 may include the line regulation unit 331 and the reference wave generating unit 333. Here, the line regulation unit 331 receives the line voltage detected by the line voltage sensing unit 60 to generate a line current varied according to the magnitude of the line voltage. Then, the reference wave generating unit 333 has a charge time varied according to the ramp current that the line current subtracted from the constant current source, and generates and outputs the PWM carrier signal having a variable frequency. For example, the PWM carrier signal output from the reference wave generating unit 333 is input to the PWM signal generating unit 35, for example, specifically, the pulse signal generating unit 351 of FIG. 2.

Here, referring to FIG. 3, when the line voltage Vline is increased, the line current Iline in the line regulator unit is increased, and thus, the ramp current Cramp of the reference wave generating unit 333 is reduced. Accordingly, the voltage charged to the capacitor Cramp is reduced, and the frequency of the PWM carrier signal output from the reference wave generating unit 333, for example, the PWM carrier signal output from the flip-flop circuit of FIG. 3. On the other hand, when the line voltage Vline is reduced, the ramp current Iramp is increased, and the frequency of the PWM carrier signal output from the reference wave generating unit 333, for example, the PWM carrier signal output from the flip-flop circuit of FIG. 3.

Next, the PWM signal generating unit 35 of the switching control unit 30 will be described in detail with reference to FIG. 2.

Referring to FIG. 2, the PWM signal generating unit 35 compares the comparison signal output from the voltage comparing unit 31 with the PWM carrier signal output from the oscillator unit 33 to generate a duty-adjusted PWM signal.

Here, according to one example, the PWM signal generating unit 35 may include the pulse signal generating unit 351 and the latch unit 353. In FIG. 2, the pulse signal generating unit 351 compares the comparison signal output from the voltage comparing unit 31 with the PWM carrier signal output from the oscillator unit 33 to generate a pulse signal. Then, the latch unit 353 latches the pulse signal output from the pulse signal generating unit 351 in response to the reference, clock signal generated and output from the oscillator unit 33 according to the PWM carrier signal. For example, the latch unit 353 receives a reference clock signal generated and output from the reference wave generating unit 333 of the oscillator unit 33, specifically, the clock generating unit 333b, according to the PWM carrier signal. Here, the latch unit 353 may latch the pulse signal output from the pulse signal generating unit 351 in response to the reference clock signal to provide the pulse signal to the control signal output unit 37.

Next, referring to FIG. 2, the control signal output unit 37 of the switching control unit 30 will be described. In FIG. 2, the control signal output unit 37 outputs a control signal for controlling the plurality of switches SW1, SW2 and SW3 according to the PWM signal output from the PWM signal generating unit 35 and the line voltage detected by the line voltage sensing unit 60.

Here, referring to FIG. 2, in one example, the control signal output unit 37 may include the buffer unit 371 and the demux unit 373. The buffer unit 371 buffers a level of the signal output from the PWM signal generating unit 35. The demux unit 373 can output a control signal for driving any one of the plurality of switches SW1, SW2 and SW3 (20) according to the signal output from the buffer unit 371 in response to the signal of the line voltage detected by the line voltage sensing unit 60. For example, demux unit 373 can output a control signal for driving any one of the plurality of switches SW1, SW2 and SW3 (20) according to the signal output from the buffer unit 371 in response to the output of the ADC 311a for converting the line voltage into a digital signal.

Next, an LED direct-driving method according to a third embodiment of the present invention will be described in detail with reference to the accompanying drawings. Here, the LED direct-driving circuits according to the first embodiment, the LED direct-driving devices according to the second embodiment, and FIGS. 1 to 5 may be referenced, and overlapping descriptions will be omitted.

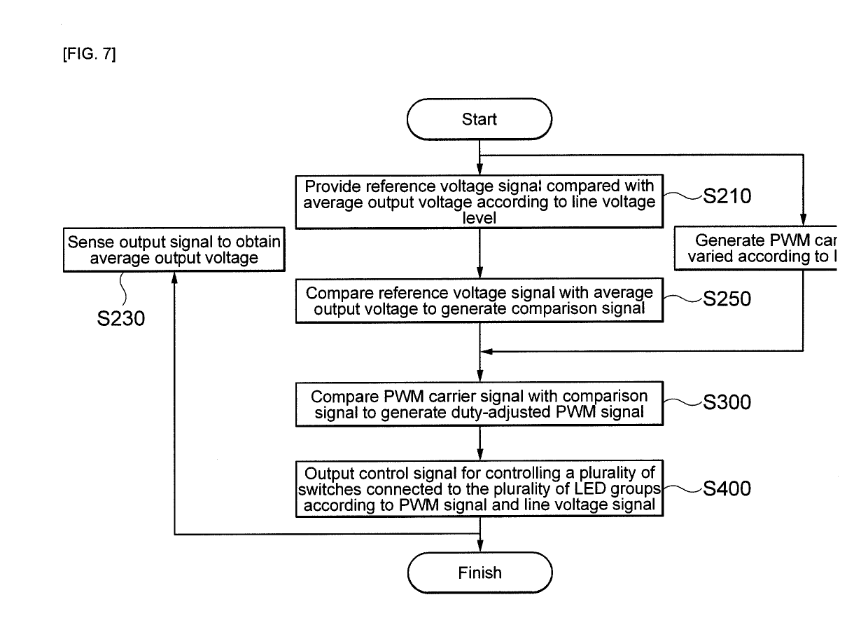

FIG. 6 is a flowchart schematically showing an LED direct-driving method according to another embodiment of the present invention, and FIG. 7 is a flowchart schematically showing an LED direct-driving method according to still another embodiment of the present invention.

The LED direct-driving method according to the third embodiment will be described with reference to FIG. 6. In the LED direct-driving method, the LED unit 10 having the plurality of LED groups G1, G2 and G3 serially connected to each other provides, for example, an input voltage having rectified AC power, and the plurality of switches SW1, SW2 and SW3 respectively connected to the plurality of LED groups G1, G2 and G3 are turned ON to emit light from at least one LED group serially connected to the corresponding switch.

Here, in one example, the LED direct-driving method may include a reference signal frequency change step S100, a voltage comparing step S200, a PWM signal generating step S300 and a control signal output step S400.

Referring to FIG. 6, in the reference signal frequency change step S100, a PWM carrier signal having a frequency varied according to a line voltage sensed from an input voltage of the LED unit 10 is generated and output. For example, the oscillator unit 33 of FIGS. 1 and/or 2 generates and outputs the PWM carrier signal having a frequency varied according to the line voltage sensed by the input voltage of the LED unit 10. Here, the input voltage input to the LED unit 10 can be detected by, for example, the line voltage sensing unit 60 of FIG. 2 as the line voltage through the voltage distribution.

While directly not shown, referring to the oscillator unit 33 of FIG. 3, in one example, the reference signal frequency change step S100 may include generating (not shown) a line current according to the line voltage, for example, in the line regulation unit 331 of FIG. 3, and generating (not shown) the PWM carrier signal having a frequency varied, for example, in the reference wave generating unit 333 of FIG. 3. The line regulation unit 331 of FIG. 3 receives, for example, the line voltage detected by the line voltage sensing unit 60 of FIG. 2 to generate the line current varied according to the magnitude of the line voltage. Then, in generating the PWM carrier signal from the reference wave generating unit 333 of FIG. 3, the capacitor is charged by the ramp current that the line current is subtracted from the constant current source, and the PWM carrier signal is generated and output. Here, the charge time is varied according to the magnitude of the line voltage, and thus, the frequency of the PWM carrier signal output after charge to the capacitor Cramp of FIG. 3 is varied. For example, the PWM carrier signal may be a ramp wave, a triangle wave, a sawtooth wave, or the like, and in one example, the PWM carrier signal output in generating the PWM carrier signal, for example, the ramp wave, may be provided to the PWM signal generating step S300, for example, specifically, in a pulse signal generating step (not shown, to be described later).

The voltage comparing step S200 in the LED direct-driving method according to one example will be described with reference to FIGS. 6 and/or 7.

Referring to FIGS. 6 and/or 7, in the voltage comparing step S200, the signal according to the line voltage sensed by the input voltage of the LED unit 10 is compared with the output voltage of the LED unit 10, and the comparison signal is output. For example, the voltage comparing step S200 of FIG. 6 may be performed in the voltage comparing unit 31 of FIGS. 1 and/or 2. Here, the line voltage compared in the voltage comparing step S200 may be, for example, the line voltage detected by the line voltage sensing unit 60 of FIG. 2.

Referring to FIG. 7, in one example, the voltage comparing step S200 of FIG. 6 may include a reference signal providing step S210, an averaging step S230 and a comparison output step S250.

First, the reference signal providing step S210 of the voltage comparing step S200 will be described with reference to FIG. 7. In FIG. 7, in the reference signal providing step S210, the reference voltage signal is generated according to the line voltage, and the generated reference voltage signal is provided to the comparison output step S250 (described later). For example, here, the reference voltage signal may be determined according to the line voltage at a certain instant.

Here, according to one example, the reference signal providing step S210 of FIG. 7 may include, while not shown, a reference voltage generating step, an analog-digital conversion step and a digital-analog conversion step.

In the reference voltage generating step (not shown) of the reference signal providing step S210, the reference voltage signal is generated from the line voltage. Here, the reference voltage signal may be a signal having a plurality of levels according to the line voltage levels. For example, in the reference voltage generating step, a plurality of levels of reference voltage signals are generated from the reference voltage generating unit 311c of FIG. 2, and any one of the plurality of levels of generated reference voltage signals may be selected according to the digital signal provided through the digital-analog conversion step and the analog-digital conversion step to be provided to the comparison output step S250.

Next, in the analog-digital conversion step (not shown) of the reference signal providing step S210, for example, the digital signal according to the level of the line voltage is generated in the ADC of FIG. 2, and the digital signal can be provided to the control signal output step S400 and the digital-analog conversion step.

Next, in the digital-analog conversion step (not shown) of the reference signal providing step S210, the digital signal generated in the analog-digital conversion step is received. Here, in the digital-analog conversion step, the analog reference voltage signal generated in the reference voltage generating step can be selected according to the input digital signal to be provided to the voltage comparing step S200 of FIG. 6, specifically, the comparison output step S250 of FIG. 7.

Next, the averaging step S230 and the comparison output step S250 of the voltage comparing step S200 of FIG. 6 will be described with reference to FIG. 7. In the averaging step S230 of FIG. 7, the sensed output signal of the LED unit 10 is received to average values of the output voltages. Next, in the comparison output step S250 of FIG. 7, the average output voltage generated in the averaging step S230 is compared with the reference voltage signal provided in the reference signal providing step S210 to output the comparison signal. The comparison signal output in the comparison output step S250 can be provided to the PWM signal generating step S300, for example, specifically, a pulse signal generating step (not shown, described later).

Next, the PWM signal generating step S300 of the LED direct-driving method according to one example will be described with reference to FIGS. 6 and/or 7.

Referring to FIGS. 6 and/or 7, in the PWM signal generating step S300, the PWM carrier signal having a frequency output and varied in the reference signal frequency change step S100 is compared with the comparison signal output from the voltage comparing step S200 to generate a duty-adjusted PWM signal. For example, the PWM signal generating step S300 can be performed in the PWM signal generating unit 35 of FIGS. 1 and/or 2.

While not shown, referring to FIG. 2, the PWM signal generating step S300 may include a pulse signal generating step and a latch step. Here, in the pulse signal generating step (not shown), the PWM carrier signal having a frequency varied and output in the reference signal frequency change step S100 is compared with the comparison signal output in the voltage comparing step S200 to generate and output the pulse signal. Next, in the latch step (not shown), the pulse signal output in response to the reference clock signal output in the reference signal frequency change step S100 according to the PWM carrier signal is latched. Here, referring to FIG. 3, the reference clock signal is additionally generated according to the PWM carrier signal having a frequency varied in the reference signal frequency change step S100. That is, in the carrier signal generating unit 333a of FIG. 3, the PWM carrier signal having a frequency varied according to the line voltage is generated and output, the generated PWM carrier signal is input to and compared by the comparator of the clock generating unit 333b of FIG. 3, and the reference clock signal is generated and output.

Next, the control signal output step S400 of the LED direct-driving method according to one example will be described with reference to FIGS. 6 and/or 7.

Referring to FIGS. 6 and/or 7, in the control signal output step S400, a control signal for controlling the plurality of switches SW1, SW2 and SW3 according to the PWM signal output from the PWM signal generating step S300 and the line voltage is output. For example, the control signal output step S400 can be performed in the control signal output unit 37 of FIGS. 1 and/or 2.

Here, while not shown, reviewing the control signal output unit 37 of FIG. 2, the control signal output step S400 may include a buffering step and a switch driving step. For example, in the buffering step (not shown) performed in the buffer unit 371 of FIG. 2, the signal output in the PWM signal generating step S300 is buffered. Next, for example, reviewing the switch driving step (not shown) performed in the demux unit 373 of FIG. 2, for example, a control signal for driving any one of the plurality of switches SW1, SW2 and SW3 according to the signal output in the buffering step in response to the signal with respect to the line voltage detected by the line voltage sensing unit 60 may be output. Here, in the switch driving step (not shown), for example, a control signal for driving any one of the plurality of switches SW1, SW2 and SW3 according to the signal output in the buffering step in response to the digital signal provided by converting the line voltage signal detected by the line voltage sensing unit 60 into the digital signal may be output.

Output characteristics of the plurality of LED groups G1, G2 and G3 according to the first to third embodiments will be described. FIG. 4 is a graph schematically showing an output waveform of the LED direct-driving circuit according to one example of the present invention, and FIG. 5 is a graph showing averages of currents flowing through the LED groups and output voltages of the LED groups of the LED direct-driving circuit according to one example of the present invention.

In FIG. 4, for example, a reference value of a peak value of the input voltage Vin is 311V (=220 Vrms). In this case, when the input voltage Vin is 370V shown by dot lines, i.e., when the input voltage Vin is increased, a duty width is adjusted to lower the duty, and the frequency is reduced to uniformly maintain the current capacity. The input voltage of FIG. 4 has a sine wave shape, the number of LEDs is adjusted according to the line voltage sensed by the input voltage, and as shown in FIG. 4, the duty is adjusted. In particular, here, when a peak value of the input voltage Vin or the line voltage is increased or decreased, the frequency is adjusted to compensate the increase or decrease. For example, when the peak value of the Vin is increased, the frequency is reduced so that the peak value of the Vin is adjusted to be equal to a reference value of 311V.

In FIG. 5, lout (first group) is a current signal flowing through each section of the first LED group G1, lout (second group) is a current flowing through each section of the first and second LED groups G1 and G2, and lout (third group) is a current flowing through each section of the third LED groups G1, G2 and G3. In FIG. 5, Vlsen_avg represents a signal averaged by sensing the output currents of the plurality of LED groups G1, G2 and G3.

Referring to FIG. 4, according to the first to third embodiments of the present invention, a duty-adjusted control signal for controlling the switches SW1, SW2 and SW3 connected to the LED groups G1, G2 and G3, respectively, can be activated using a difference value between the reference voltage signal according to the line voltage Vline according to the input voltage Vin input to the plurality of LED groups G1, G2 and G3 and the output voltage Vout output from the plurality of LED groups G1, G2 and G3. Corresponding to the control signal, some or all of the LED groups of the first to third LED groups G1, G2 and G3 serially connected to the switches, to which the control signal is applied, are driven, and at this time, the output signals of the LED groups may have a step shape as shown in FIG. 4.

For example, a first section S1 and a sixth section S6 of the graph of FIG. 5 show that the first switch unit SW1 is activated to drive only the first LED group G1, and in these sections, the average output voltage corresponding to N*Vf can be generated. A second section S2 and a fifth section S5 show that the second switch unit SW2 is activated to operate the first and second LED groups G1 and G2, and in these sections, the average output voltage corresponding to 2N*Vf can be generated. In addition, a third section S3 and a fourth section S4 show that the third switch unit SW3 is activated to drive the first to third LED groups G1, G2 and G3, and in these sections, the average output voltage corresponding to 3N*Vf can be generated.

Meanwhile, when the input voltage Vin input to the LED group or the voltage-distributed line voltage Vline is increased, the duty can be decreased as in the first to third sections S1, S2 and S3 using the switching control unit 30 of FIGS. 1 and/or 2. On the other hand, when the input voltage Vin input to the LED group or the voltage-distributed line voltage is reduced, the duty can be increased as in the fourth to sixth sections S4, S5 and S6 using the switching control unit 30 of FIGS. 1 and/or 2.

As described above, according to the embodiment of the present invention, the duty is adjusted according to the increase sections S1, S2 and S3 and the decrease sections S4, S5 and S6 of the line voltage Vline or the input voltage Vin, and the driving frequency is varied according to the line voltage, uniformly maintaining the current capacity of the increase sections S1, S2 and S3 and the decrease sections S4, S5 and S6. Accordingly, the line regulation characteristics can be further improved to solve problems related to heat generation due to power loss.

As can be seen from the foregoing, according to the embodiment of the present invention, the frequency of the PWM carrier signal can be varied according to the line voltage to uniformly maintain the current capacity provided to the LED, improving the line regulation.

Embodiments of the invention have been discussed above with reference to the accompanying drawings. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention.

What is claimed is:

1. A light emitting diode (LED) direct-driving circuit comprising:
an LED unit having a plurality of LED groups serially connected to each other;
a switching unit including a plurality of switches respectively connected to the plurality of LED groups, each switch configured to emit light from at least one LED group serially connected to the corresponding switch according to an ON operation; and
a switching control unit configured to compare a signal according to a line voltage sensed from an input voltage of the LED unit with an output voltage of the LED unit to calculate a comparison value, generate a pulse width modulation (PWM) carrier signal having a frequency varied according to the line voltage, and output a control signal for controlling the switching unit by comparing the comparison value with the frequency-varied PWM carrier signal.

2. The LED direct-driving circuit according to claim 1, wherein the switching control unit comprises:
a voltage comparing unit configured to compare the signal according to the line voltage sensed by the input voltage of the LED unit with the output voltage of the LED unit to output a comparison signal;
an oscillator unit configured to generate and output the PWM carrier signal having a frequency according to the line voltage;
a PWM signal generating unit configured to compare the comparison signal output from the voltage comparing unit with the PWM carrier signal output from the oscillator unit to generate a duty-adjusted PWM signal; and
a control signal output unit configured to output a control signal for controlling the switching unit according to the PWM signal and the line voltage output from the PWM signal generating unit.

3. The LED direct-driving circuit according to claim 2, wherein the voltage comparing unit comprises:
a reference signal providing unit configured to generate and provide a reference voltage signal according to the line voltage;
an averaging unit configured to receive the output voltage of the LED unit and average a value of the output voltage; and
a comparison amplification unit configured to compare an average output voltage generated from the averaging unit with the reference voltage signal to output a comparison signal.

4. The LED direct-driving circuit according to claim 3, wherein the reference signal providing unit comprises:
a reference voltage generating unit configured to generate a reference voltage signal from the line voltage;
an analog-digital converter (ADC) configured to generate a digital signal according to a level of the line voltage and provide the digital signal to the control signal output unit; and
a digital-analog converter (DAC) configured to receive a digital signal generated from the ADC and select an analog reference voltage signal generated from the reference voltage generating unit according to the digital signal to provide the analog reference voltage signal to the voltage comparing unit.

5. The LED direct-driving circuit according to claim 4, wherein the control signal output unit comprises:
a buffer unit configured to buffer a signal output from the PWM signal generating unit; and
a demux unit configured to output a control signal for driving any one of the plurality of switches of the switching unit according to a signal output from the buffer unit in response to the ADC.

6. The LED direct-driving circuit according to claim 2, wherein the oscillator unit comprises:
a line regulation unit configured to receive the line voltage and generate a line current varied according to a magnitude of the line voltage; and
a reference wave generating unit, in which a charge time is varied by a ramp current that the line current is subtracted from a constant current source, configured to generate and output the PWM carrier signal having a variable frequency.

7. The LED direct-driving circuit according to claim 2, wherein the PWM signal generating unit comprises:
a pulse signal generating unit configured to compare the comparison signal output from the voltage comparing unit with the PWM carrier signal output from the oscillator unit to generate a pulse signal; and
a latch unit configured to latch the pulse signal output from the pulse signal generating unit in response to a reference clock signal generated and output from the oscillator unit according to the PWM carrier signal.

8. The LED direct-driving circuit according to claim 2, wherein the LED direct-driving circuit comprises:
a power supply unit configured to rectify alternate current (AC) power to provide the input voltage to the LED unit; and
a line voltage sensing unit configured to distribute the input voltage provided from the power supply unit to detect the distributed line voltage.

9. An LED direct-driving device comprising:
a power supply unit configured to rectify AC power to provide an input voltage;
a line voltage sensing unit configured to distribute the input voltage provided from the power supply unit to detect a distributed line voltage;
a plurality of LED groups configured to receive the input voltage from the power supply unit and including at least one LED serially connected to each other;
a plurality of switches respectively connected to the plurality of LED groups and emitting light from at least one LED group serially connected to the corresponding switch according to an ON operation;
an output signal sensing unit connected to a lower end of the plurality of switches and configured to detect an output voltage of the plurality of LED groups; and
a switching control unit configured to compare a signal according to the line voltage detected by the line voltage sensing unit with an output voltage detected by the output signal sensing unit to calculate a comparison value, generate a PWM carrier signal having a frequency varied according to the detected line voltage, and compare the comparison value with the frequency-varied PWM carrier signal to output a control signal for controlling the plurality of switches.

10. The LED direct-driving device according to claim 9, wherein the switching control unit comprises:
a voltage comparing unit configured to compare a signal according to the line voltage detected by the line voltage sensing unit with an output voltage detected by the output signal sensing unit to output a comparison signal;
an oscillator unit configured to generate the PWM carrier signal having a frequency varied according to the detected line voltage;
a PWM signal generating unit configured to compare the comparison signal output from the voltage comparing unit with the PWM carrier signal output from the oscillator unit to generate a duty-adjusted PWM signal; and
a control signal output unit configured to a control signal for controlling the plurality of switches according to the PWM signal output from the PWM signal generating unit and the detected line voltage.

11. The LED direct-driving device according to claim 10, wherein the voltage comparing unit comprises:
a reference signal providing unit configured to generate and provide a reference voltage signal according to the line voltage;
an averaging unit configured to average a value of the output voltage detected by the output signal sensing unit; and
a comparison amplification unit configured to compare an average output voltage generated from the averaging unit with the reference voltage signal to output a comparison signal.

12. The LED direct-driving device according to claim 11, wherein the reference signal providing unit comprises:
a reference voltage generating unit configured to generate a reference voltage signal from the line voltage;
an ADC configured to generate a digital signal according to a level of the detected line voltage and provide the digital signal to the control signal output unit; and
a DAC configured to receive a digital signal generated from the ADC and select an analog reference voltage signal generated from the reference voltage generating unit according to the digital signal to provide the an analog reference voltage signal to the voltage comparing unit.

13. The LED direct-driving device according to claim 12, wherein the control signal output unit comprises:
a buffer unit configured to buffer a signal output from the PWM signal generating unit; and
a demux unit configured to output a control signal for driving any one of the plurality of switches according to a signal output from the buffer unit in response to an output of the ADC.

14. The LED direct-driving device according to claim 10, wherein the oscillator unit comprises:
a line regulation unit configured to receive the line voltage from the line voltage sensing unit to generate a line current varied according to a magnitude of the line voltage; and
a reference wave generating unit, in which a charge time is varied by a ramp current that the line current is subtracted from a constant current source, configured to generate and output the PWM carrier signal having a variable frequency.

15. The LED direct-driving device according to claim 10, wherein the PWM signal generating unit comprises:
a pulse signal generating unit configured to compare the comparison signal output from the voltage comparing unit with the PWM carrier signal output from the oscillator unit to generate a pulse signal; and
a latch unit configured to latch the pulse signal output from the pulse signal generating unit in response to a reference clock signal generated and output from the oscillator unit according to the PWM carrier signal.

16. An LED direct-driving method of providing an input voltage to an LED unit serially connected to a plurality of LED groups, controlling a plurality of switches respectively connected to the plurality of LED groups to perform an ON operation, and emitting light from at least one LED group serially connected to a corresponding switch, the LED direct-driving method comprising:
a reference signal frequency change step of generating and outputting a PWM carrier signal having a frequency varied according to a line voltage sensed from an input voltage of the LED unit;
a voltage comparing step of comparing a signal according to the line voltage with an output voltage of the LED unit to output a comparison signal;
a PWM signal generating step of comparing the PWM carrier signal having a frequency varied and output in the reference signal frequency change step with the comparison signal output from the voltage comparing step to generate a duty-adjusted PWM signal; and
a control signal output step of outputting a control signal for controlling each of the plurality of switches according to the PWM signal output from the PWM signal generating step and the line voltage.

17. The LED direct-driving method according to claim 16, wherein the reference signal frequency change step comprises:
a step of receiving the line voltage and generating a line current varied according to a magnitude of the line voltage; and
a step of varying a charge time by a ramp current that the line current is subtracted from a constant current source and generating and outputting the PWM carrier signal having a variable frequency.

18. The LED direct-driving method according to claim 16, wherein the voltage comparing step comprises:
a reference signal providing step of generating and providing a reference voltage signal according to the line voltage;
an averaging step of detecting an output voltage of the LED unit and averaging a value of the detected output voltage; and
a comparison output step of comparing an average output voltage generated in the averaging step with the reference voltage signal provided in the reference signal providing step to output a comparison signal.

19. The LED direct-driving method according to claim 18, wherein the reference signal providing step comprises:
a reference voltage generating step of generating a reference voltage signal from the line voltage;
an analog-digital conversion step of generating a digital signal according to a level of the line voltage and providing the digital signal to the control signal output step; and
a digital-analog conversion step of receiving the digital signal generated in the analog-digital conversion step and selecting an analog reference voltage signal generated in the reference voltage generating step according to the digital signal to provide the analog reference voltage signal to the comparison output step,
wherein the control signal output step comprises:
a step of buffering a signal output in the PWM signal generating step; and
a step of outputting a control signal for driving any one of the plurality of switches according to a signal output after the buffering in response to an output of the analog-digital conversion step.

20. The LED direct-driving method according to claim 16, wherein a reference clock signal is additionally generated and output according to the PWM carrier signal having a frequency varied in the reference signal frequency change step, and
the PWM signal generating step comprises:
a step of comparing the PWM carrier signal having a frequency varied and output in the reference signal frequency change step with the comparison signal output in the voltage comparing step to generate and output a pulse signal; and
a step of latching the pulse signal output in response to the reference clock signal output in the reference signal frequency change step.
